(19) United States
(12) Patent Application Publication
(10) Pub. No.: US 2016/0101944 A1
(43) Pub. Date: Apr. 14, 2016

(54) CONVEYOR DEVICE WITH VARIABLE ANGLE ADJUSTMENT

(71) Applicants: IEI Integration Corp., New Taipei City (TW); Armorlink SH Corp., Shang-Hai City (CN)

(72) Inventor: Yu-Tsung Chang, New Taipei City (TW)

(21) Appl. No.: 14/542,677

(22) Filed: Nov. 17, 2014

(30) Foreign Application Priority Data
Oct. 8, 2014 (CN) 201410524609.9

(51) Int. Cl. B65G 21/14; B65G 23/04; B65G 43/00; B65G 15/28

(52) U.S. Cl. CPC B65G 21/14; B65G 15/28; B65G 23/04; B65G 43/00

(57) ABSTRACT

A conveyor device includes two arms rotatably pivoted to each other and rollers disposed at each end and a pivot of the two arms, and a conveyor belt is wrapped around the rollers. As the two arms are rotated by a certain angle with each other, a surface of the conveyor belt is made bendable with variable angle. A returning section of the conveyor belt is further restrained by a slideway at the bottom of the arms and guided to follow a specific path, while a detection device may further be disposed at a side of a conveying section of the conveyor belt for providing a variety of implementations.

### BACKGROUND OF THE INVENTION

1. Field of the Invention

The present invention relates to a conveyor device, and more particularly, to a conveyor device with variable angle adjustment.

2. Description of the Prior Art

Conveyor devices have characteristics of simple operation, easy maintenance, low transportation cost, and reduction of transportation distance. Therefore, conveyor devices are widely used in agriculture, mining industry, and transportation communication for conveying various solid objects or packaged goods, which lower the cost for construction and save manpower and material resources. However, conveyor devices applied in these situations are usually prebuilt, leading to low mobility. Furthermore, conventional conveyor devices are so built to have a flat straight track or a flat curve track that face limitation of where they can be applied. For example, it is usually required to combine plural conveyor devices in order to make them work when a height difference exists between two transportation ends, which makes it difficult to use a single flat conveyor device.

### SUMMARY OF THE INVENTION

In order to solve the problems mentioned above and enhance mobility and extensity of application where a conveyor device is used, the present invention provides a conveyor device with variable angle adjustment.

According to the invention, a conveyor device with variable angle includes a motor, a first roller, a second roller, a first arm, a second arm, a third roller, and a conveyor belt. The motor drives the first roller to rotate. The first arm has a first end and a second end opposite to each other. The first roller is disposed at the first end. The second arm has a third end and a fourth end opposite to each other. The third end is pivoted to the second end of the first arm, such that the second arm is rotatable relative to the first arm. The second roller is disposed at the fourth end. The third roller is disposed at a location where the first arm is pivoted to the second arm. The conveyor belt is wrapped around the first roller, the third roller, and the second roller. A conveying section is formed on a side of the conveyor belt between the first roller and the second roller and a returning section is formed on another side opposite to the conveying section. The first roller is adapted to be driven by the motor to drive the conveyor belt to rotate around the first roller, the third roller, and the second roller.

According to the invention, the second arm is disposed at a non-pivoting position relative to the first arm and a straight surface is formed on the conveying section when the first roller, the third roller, and the second roller are arranged in a line. When the second arm is rotated by an angle to a pivoting position relative to the first arm, the first roller, the third roller, and the second roller are arranged in a triangle and the conveying section is divided into a first section and a second section including the angle, the first section is located between the first roller and the third roller, and the second section is located between the third roller and the second roller.

According to the invention, the conveyor device further includes an adjustment device disposed at a side of the third end of the second arm. The third end has a plurality of positioning slots around a periphery. When the second arm is rotated by the angle relative to the first arm, the adjustment device selectively engages with one of the plurality of the positioning slots corresponding to the angle, so as to maintain the second arm at the angle.

According to the invention, the adjustment device is pivoted to the first arm. The adjustment device includes a hook, and the hook selectively engages with one of the plurality of the positioning slots when the adjustment device rotates.

According to the invention, the conveyor belt is a caterpillar track. The first arm includes a first returning slideway. The second arm includes a second returning slideway. The returning section of the conveyor belt is disposed between the first roller and second roller passing through the first returning slideway and the second returning slideway.

According to the invention, the first returning slideway includes a first arc surface at a side near the third roller and the second returning slideway includes a second arc surface at a side near the third roller.

According to the invention, the angle is between 0 degree and 90 degrees. The second arm is disposed at the non-pivoting position relative to the first arm when the angle is 0 degree. When the angle is 90 degrees, the first arc surface is connected to the second arc surface, such that a 90-degree slideway with a transmission angle is formed by the first returning slideway and the second returning slideway.

According to the invention, the transmission angle is between 130 degrees and 150 degrees.

According to the invention, the returning section is restrained by the first returning slideway and the second returning slideway and moves along the first returning slideway and the second returning slideway.

According to the invention, the conveyor belt is a tensioned leather belt.

According to the invention, the fourth end of the second arm includes a sliding slot. An axle of the second roller is disposed in the sliding slot, such that the second roller is slidable relative to the fourth end along a direction.

According to the invention, when the second arm rotates to the pivoting position by the angle relative to the first arm, the second roller slides at the fourth end along the direction away from the third roller and the second roller provides a tension force on the conveyor belt.

According to the invention, the conveyor device further includes a detection device disposed at the second arm and located at a side of the conveyor belt.

According to the invention, the detection device is a camera, a light blocking counter, or a scanner.

The conveyor device with variable angle adjustment of the present invention can bridge between two transportation ends with different heights in a flexible manner, so as to enhance convenience and mobility of carrier transportation.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a schematic diagram of a conveyor device according to an embodiment of the present invention.

FIG. 2 is a diagram showing the conveyor device in a non-pivoting position.

FIG. 3 and FIG. 4 are side view diagrams of partial members of the conveyor device shown in FIG. 2 according to the embodiment of the present invention.

FIG. 5 is a diagram of an adjustment device of the conveyor device showing a second arm maintained at a specific pivoting position.

FIG. 6 is a side view diagram of partial members of the conveyor device shown in FIG. 5 according to the embodiment of the present invention.

FIG. 7 is a side view diagram of the conveyor device showing the second arm rotated by a maximum angle relative to the first arm according to the embodiment of the present invention.

### DETAILED DESCRIPTION

Certain terms are used throughout the description and following claims to refer to particular components. As one skilled in the art will understand, electronic equipment manufacturers may refer to a component by different names. This document does not intend to distinguish between components that differ in name but not function. In the following description and in the claims, the terms “include” and “comprise” are used in an open-ended fashion, and thus should be interpreted to mean “include, but not limited to . . . ” In addition, to simplify the descriptions and make it more convenient to compare between each embodiment, identical components are marked with the same reference numerals in each of the following embodiments. Please note that the figures are only for illustration and the figures may not be to scale. Also, the term “couple” is intended to mean either an indirect or direct electrical/mechanical connection. Thus, if a first device is coupled to a second device, that connection may be through a direct electrical/mechanical connection, or through an indirect electrical/mechanical connection via other devices and connections.

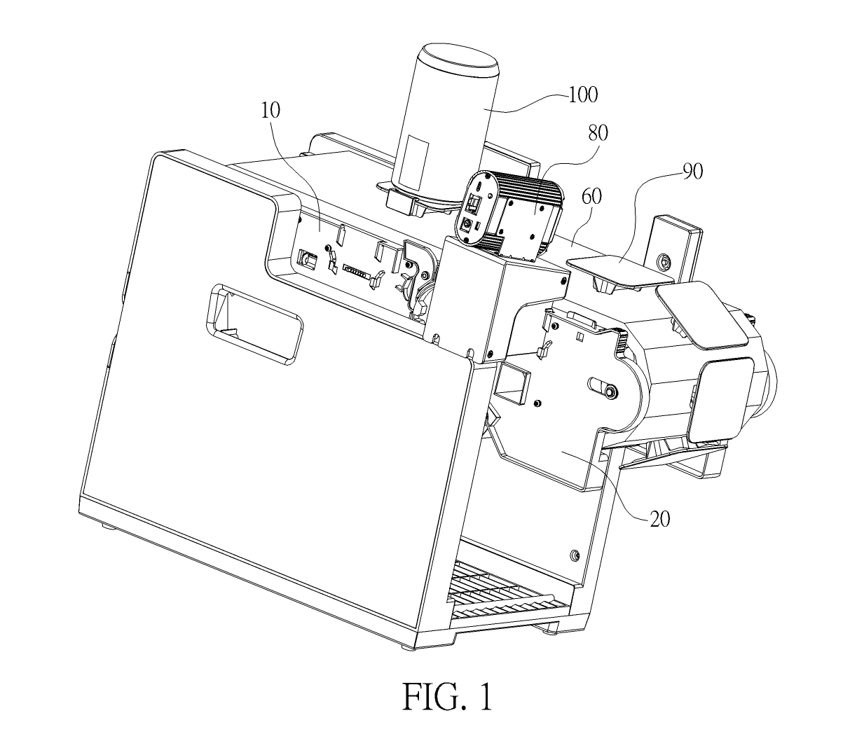

FIG. 1 is a schematic diagram of a conveyor device 1 according to an embodiment of the present invention. The conveyor device 1 includes a first arm 10 and a second arm 20 rotatably pivoted to each other and thus has a characteristic of variable angle adjustment. When two ends of the conveyor device 1 are bridged between two objects or two platforms, the conveyor device 1 is capable of providing a proper transportation passage between the two objects or the two platforms with different heights. The conveyor device 1 can utilize a plurality of carrier seats 90 on a conveyor belt 60 for placing carriers 100. A detection device 80, such as a camera, a light blocking counter, or a scanner, may further be disposed at a side of the conveyor belt 60 on the second arm 20 for providing a function of image capturing identification, counting, or barcode scanning to the carrier 100, depending on different application situations.

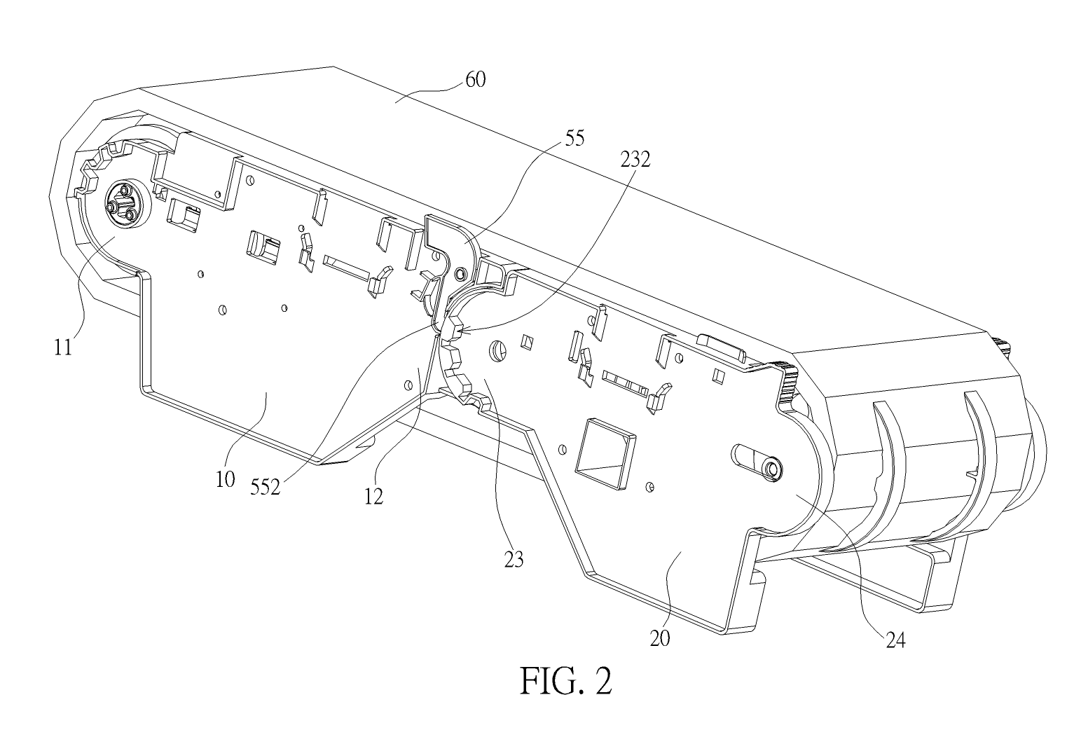

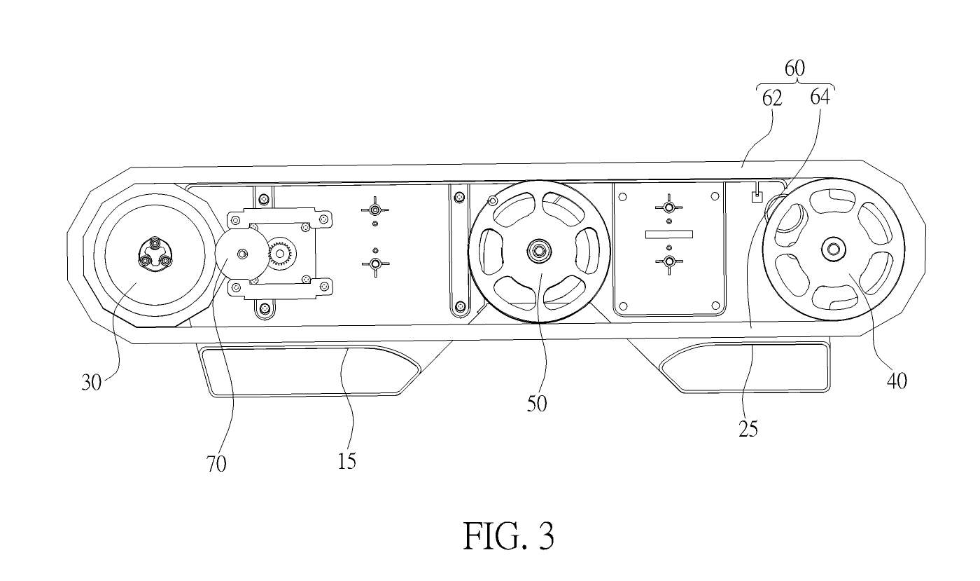

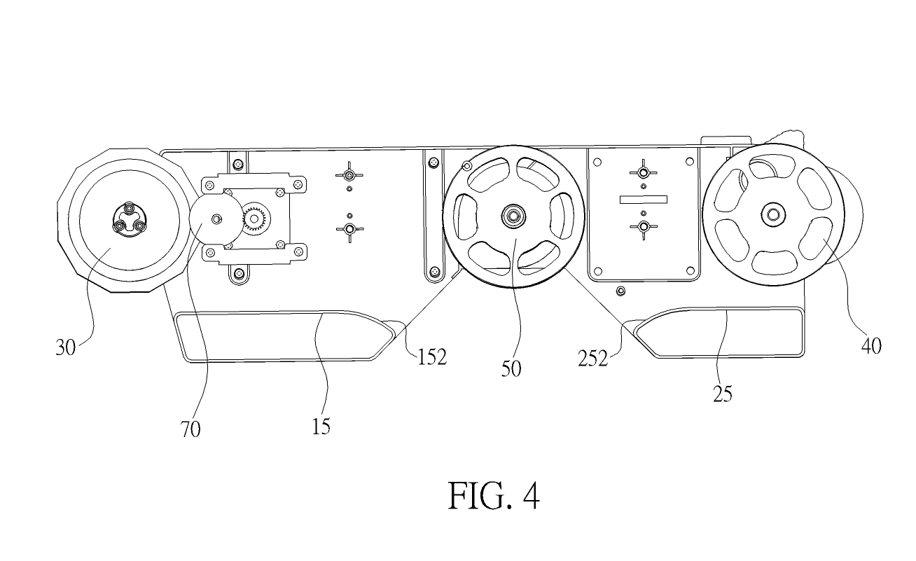

Please also refer to FIG. 2 to FIG. 4. FIG. 2 is a diagram showing the conveyor device 1 in a non-pivoting position. FIG. 3 and FIG. 4 are side view diagrams of partial members of the conveyor device 1 shown in FIG. 2 according to the embodiment of the present invention. In the embodiment of the present invention, the conveyor device 1 includes the first arm 10, the second arm 20, a first roller 30, a second roller 40, a third roller 50, a conveyor belt 60, and a motor 70. As aforementioned, the conveyor device 1 may further include the detection device 80 and dispose the plurality of carrier seats 90 on the conveyor belt 60. The first arm 10 has a first end 11 and a second end 12 opposite to each other and the second arm 20 has a third end 23 and a fourth end 24 opposite to each other. The first roller 30 is disposed at the first end 11 of the first arm 10. The motor 70 is linked to the first roller 30 and drives the first roller 30 to rotate. The second roller 40 is disposed at the fourth end 24 of the second arm 20. The second end 12 of the first arm 10 is pivoted to the third end 23 of the second arm 20, such that the second arm 20 is made rotatable relative to the first arm 10. The third roller 50 is disposed at a location where the first arm 10 is pivoted to the second arm 20. The conveyor belt 60 is wrapped around the first roller 30, the third roller 50, and the second roller 40. When the motor 70 drives the first roller 30 to drive the conveyor belt 60, the conveyor belt 60 rotates around the second roller 40 and the third roller 50, so as to drive the second roller 40 and the third roller 50 to rotate accordingly. The first roller 30, the second roller 40, and third roller 50 are also used for supporting the conveyor belt 60. In other words, in this embodiment, since the motor 70 drives the first roller 30, the first roller 30 is designed to be a driving wheel and the second roller 40 and the third roller 50 are designed to be driven wheels.

As shown in FIG. 3, a conveying section 62 is formed on a side of the conveyor belt 60 between the first roller 30 and the second roller 40 and a returning section 64 is formed on the other side opposite to the conveying section 62. That is to say, the conveying section 62 is located at the upper side of the conveyor device 1. When the conveyor device 1 is put to use, the conveying section 62 is used forbearing and transporting the carrier 100 with the carrier seat 90 or by directly placing the carrier 100 on a surface of the conveying section 62 without the carrier seat 90. The returning section 64 is located at the lower side of the conveyor device 1 and is usually not in the position to bear objects, but it is not limited to hereto. In another embodiment of the present invention, the carrier seat 90 can be made magnetic that is capable of attracting ferromagnetic carriers 100, or the carrier seat 90 can also hold the carrier 100 by clamping. In this way, the returning section 64 may also be configured to transport the carrier 100. It should be noted that the conveying section 62 and the returning section 64 described herein are defined by positions thereof relative to other members of the conveyor device 1. It is not limited to the functions mentioned above.

Please refer to FIG. 2. The second arm 20 is rotatable relative to the first arm 10 by pivoting the third end 23 of the second arm 20 to the second end 12 of the first arm 10. The conveyor device 1 further includes an adjustment device 55 disposed at a side of the third end 23 of the second arm 20. The third end 23 has a plurality of positioning slots 232 around a periphery. When the second arm 20 is rotated relative to the first arm 10, the adjustment device 55 can selectively engage with one of the plurality of the positioning slots 232, so as to maintain the second arm 20 at an angle relative to the first arm 10. More specifically, in an embodiment according to the invention, the adjustment device 55 is pivoted to the first arm 10 and has a hook 552. The hook 552 can selectively engage with one of the plurality of positioning slots 232 corresponding to a position of the hook 552. Additionally, FIG. 2 to FIG. 4 show that the second arm 20 is disposed at a non-pivoting position relative the first arm 10, i.e., the first roller 30, the third roller 50, and the second roller 40 are arranged in a line when the second arm 20 is at the non-pivoting position and the conveying section 62 of the conveyor belt 60 is presented with a flat straight surface at such position.

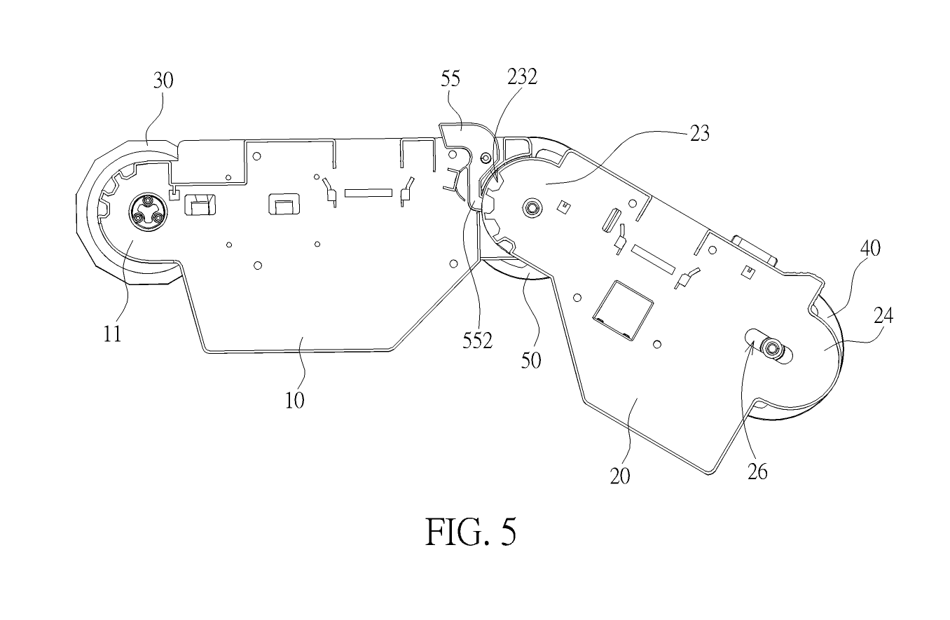

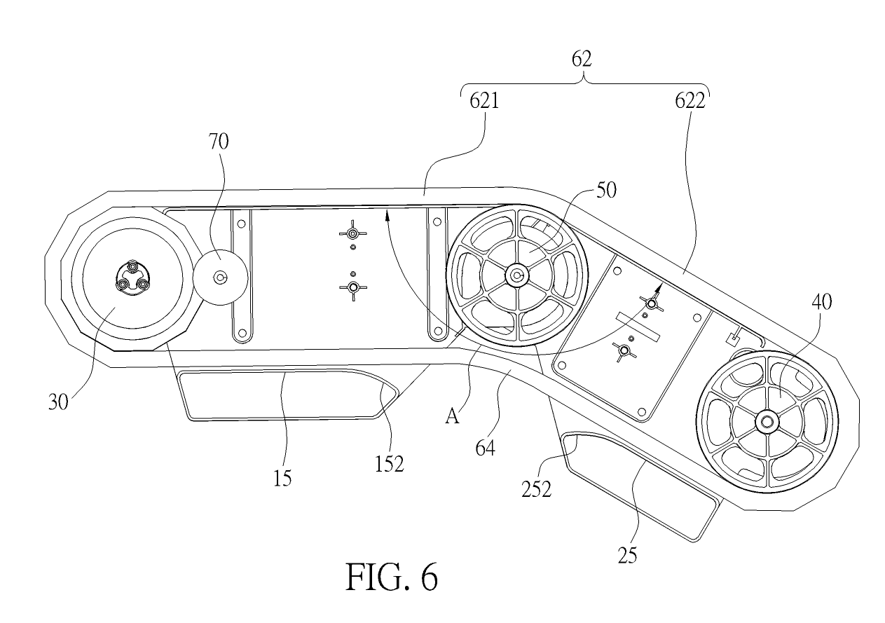

The second arm 20 and the first arm 10 can include an angle when the second arm 20 is rotated relative to the first arm 10 and departed from the non-pivoting position. Please refer to FIG. 5 and FIG. 6. FIG. 5 is a diagram of the adjustment device 55 of the conveyor device 1 showing the second arm 20 maintained at a specific pivoting position. FIG. 6 is a side view diagram of partial members of the conveyor device 1 shown in FIG. 5 according to the embodiment of the present invention. When the second arm 20 is rotated to the pivoting position shown in FIG. 5 and FIG. 6 by an angle A relative to the first arm 10, the first roller 30, the third roller 50, and the second roller 40 are arranged in a triangle, i.e., the three rollers are located at three vertexes of the triangle. Due to the third roller 50, the conveying section 62 of the conveyor belt 60 is divided by the third roller 50 into a first section 621 and a second section 622 including the angle A, wherein the first section 621 is located between the first roller 30 and the third roller 50 and the second section 622 is located between the third roller 50 and the second roller 40. When the second arm 20 is rotated to the pivoting position, it can be maintained at the angle A relative to the first arm 10 as the hook 552 of the adjustment device 55 has engagement with a positioning slot 232 corresponding to the angle A.

It should be noted that, in this embodiment, the first arm 10 further includes a first returning slideway 15 underneath, the second arm 20 further includes a second returning slideway 25 underneath, and the returning section 64 of the conveyor belt 60 is disposed between the first roller 30 and the second roller 40 passing through the first returning slideway 15 and the second returning slideway 25. Embodiments of the invention show that the conveyor belt 60 is exemplified as a caterpillar track, more specifically, a circularly shaped caterpillar track, formed by a plurality of caterpillar blocks pivoted to one another. This type of conveyor belt 60 formed by the caterpillar track has fixed perimeter, and the three rollers have to provide a necessary tension force and a fixed passage for the conveyor belt 60 when the conveyor belt 60 is wrapped around the three rollers. Therefore, the returning section 64 of the conveyor belt 60 is restrained by the first returning slideway 15 and the second returning slideway 25, so as to move along the first returning slideway 15 and the second returning slideway 25.

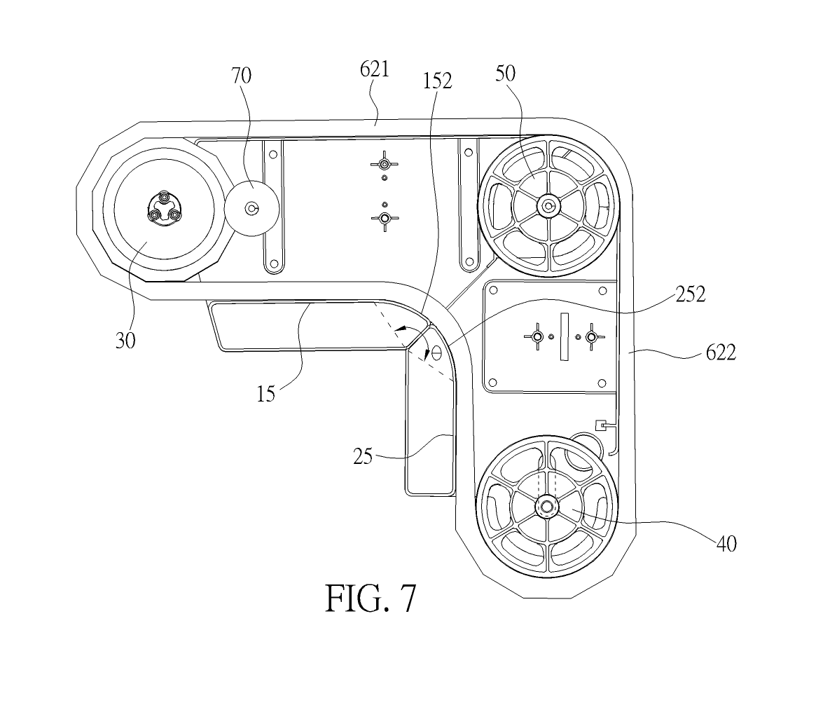

Please refer to FIG. 7. FIG. 7 is a side view diagram of the conveyor device 1 showing the second arm 20 rotated by a maximum angle relative to the first arm 10 according to the embodiment of the present invention. In the present invention, the second arm 20 can be rotated by an angle between 0 degree and 90 degrees relative to the first arm 10. When the angle is 0 degree, the second arm 20 is located at the non-pivoting position relative to the first arm 10, as shown in FIG. 2 to FIG. 4. As shown in FIG. 5 and FIG. 6, the second arm 20 is rotated to the pivoting position by a certain angle between 0 degree and 90 degrees. As shown in FIG. 7, the second arm 20 is rotated by 90 degrees, the maximum angle, relative to the first arm 10. In order to provide a proper transmission angle for the conveyor belt 60 formed by the caterpillar track at the maximum angle, as shown in FIG. 7, the first returning slideway 15 includes a first arc surface 152 at a side near the third roller 50 and the second returning slideway 25 includes a second arc surface 252 at a side near the third roller 50. The first arc surface 152 is connected to the second arc surface 252 when the second arm 20 is rotated by 90 degrees (angle A is 90 degrees) relative to the first arm 10, such that a 90-degree returning slideway with a transmission angle θ is formed by the first returning slideway 15 and the second returning slideway 25. In the present invention, the transmission angle θ is preferably between 130 degrees and 150 degrees, such that the conveyor belt 60 formed by the caterpillar track is still able to move smoothly when passing through the 90-degree (or less than 90-degree) returning slideway beneath the first arm 10 and the second arm 20.

In the aforementioned embodiment, as the conveyor belt 60 formed by the caterpillar track has a fixed perimeter, when the second arm 20 is rotated relative to the first arm 10, the second roller 40 can further be disposed at the fourth end 24 of the second arm 20 in a moveable way, so as to maintain the conveyor belt 60 in a tension status. More specifically, in this embodiment, the fourth end 24 of the second arm 20 includes a sliding slot 26 and an axle of the second roller 40 is disposed in the sliding slot 26, such that the second roller 40 is slidable relative to the fourth end 24 along a direction close to or away from the third roller 50. When the second arm 20 rotates to the pivoting position by the pivoting angle A (or a 90-degree position shown in FIG. 7) relative to the first arm 10, the second roller 40 slides at the fourth end 24 along a direction away from the third roller 50, such that the second roller 40 can provide a tension force on the conveyor belt 60, and the conveyor belt 60 may be maintained in the tension status. The sliding stress needed by the second roller 40 in the sliding slot 26 can be provided by an elastic member disposed between the second roller 40 and the second arm 20 (not shown in the figures). Besides the aforementioned embodiment with the conveyor belt 60 in the form of the caterpillar track, the caterpillar-track conveyor belt 60 configuring the first returning slideway 15 on the first arm 10, the second returning slideway 25 on the second arm 20, and including the transmission angle θ between the first returning slideway 15 and the second returning slideway 25, in another embodiment of the present invention, the conveyor belt 60 can also be in the form of a tensioned leather belt. When the conveyor belt 60 is in the form of tensioned leather belt, no returning slideway is needed for the returning section 64 of the conveyor belt 60.

The conveyor device of the present invention includes two arms rotatably pivoted to each other and rollers disposed at each end and a pivot of the two arms, and a conveyor belt is wrapped around the rollers. As the two arms are rotated by a certain angle with each other, a surface of the conveyor belt is made bendable with variable angle. A returning section of the conveyor belt is further restrained by a slideway at the bottom of the arms and guided to follow a specific path, while a detection device may further be disposed at a side of a conveying section of the conveyor belt for providing a variety of implementations. Therefore, the conveyor device with variable angle adjustment of the present invention can bridge between two transportation ends with different heights in a flexible manner, so as to enhance convenience and mobility of carrier transportation.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A conveyor device with variable angle comprising:
a motor;
a first roller, the motor driving the first roller to rotate;
a second roller;
a first arm with a first end and a second end opposite to each other, the first roller disposed at the first end;
a second arm with a third end and a fourth end opposite to each other, the third end pivoted to the second end of the first arm, such that the second arm is rotatable relative to the first arm, and the second roller disposed at the fourth end;
a third roller disposed at a location where the first arm is pivoted to the second arm; and
a conveyor belt wrapped around the first roller, the third roller, and the second roller, a conveying section formed on a side of the conveyor belt between the first roller and the second roller and a returning section formed on another side opposite to the conveying section, the first roller adapted to be driven by the motor to drive the conveyor belt to rotate around the first roller, the third roller, and the second roller.

2. The conveyor device of claim 1, wherein the second arm is disposed at a non-pivoting position relative to the first arm and a straight surface is formed on the conveying section when the first roller, the third roller, and the second roller are arranged in a line; wherein when the second arm is rotated by an angle to a pivoting position relative to the first arm, the first roller, the third roller, and the second roller are arranged in a triangle and the conveying section is divided into a first section and a second section including the angle, the first section is located between the first roller and the third roller, and the second section is located between the third roller and the second roller.

3. The conveyor device of claim 2, further comprising an adjustment device disposed at a side of the third end of the second arm, and the third end having a plurality of positioning slots around a periphery, wherein when the second arm is rotated by the angle relative to the first arm, the adjustment device selectively engages with one of the plurality of the positioning slots corresponding to the angle, so as to maintain the second arm at the angle.

4. The conveyor device of claim 3, wherein the adjustment device is pivoted to the first arm, the adjustment device comprises a hook, and the hook selectively engages with one of the plurality of the positioning slots when the adjustment device rotates.

5. The conveyor device of claim 2, wherein the conveyor belt is a caterpillar track, the first arm comprises a first returning slideway, the second arm comprises a second returning slideway, and the returning section of the conveyor belt is disposed between the first roller and second roller passing through the first returning slideway and the second returning slideway.

6. The conveyor device of claim 5, wherein the first returning slideway comprises a first arc surface at a side near the third roller and the second returning slideway comprises a second arc surface at a side near the third roller.

7. The conveyor device of claim 6, wherein the angle is between 0 degree and 90 degrees, the second arm is disposed at the non-pivoting position relative to the first arm when the angle is 0 degree, and when the angle is 90 degrees, the first arc surface is connected to the second arc surface, such that a 90-degree returning slideway with a transmission angle is formed by the first returning slideway and the second returning slideway.

8. The conveyor device of claim 7, wherein the transmission angle is between 130 degrees and 150 degrees.

9. The conveyor device of claim 5, wherein the returning section is restrained by the first returning slideway and the second returning slideway and moves along the first returning slideway and the second returning slideway.

10. The conveyor device of claim 2, wherein the conveyor belt is a tensioned leather belt.

11. The conveyor device of claim 2, wherein the fourth end of the second arm comprises a sliding slot, an axle of the second roller is disposed in the sliding slot, such that the second roller is slidable relative to the fourth end along a direction.

12. The conveyor device of claim 11, wherein when the second arm rotates to the pivoting position by the angle relative to the first arm, the second roller slides at the fourth end along the direction away from the third roller and the second roller provides a tension force on the conveyor belt.

13. The conveyor device of claim 1, further comprising a detection device disposed at the second arm and located at a side of the conveyor belt.

14. The conveyor device of claim 13, wherein the detection device is a camera, a light blocking counter, or a scanner.
